(19) United States
(12) Patent Application Publication
(10) Pub. No.: US 2013/0003205 A1
(43) Pub. Date: Jan. 3, 2013

(54) HELIOSTAT MIRROR WITH SUPPORTING RIB STRUCTURE

(76) Inventors: Robert A. Proudfoot, Santa Clara, CA (US); David K. Fork, Mountain View, CA (US); Jonathan P. Switkes, San Jose, CA (US)

(21) Appl. No.: 13/172,761

(22) Filed: Jun. 29, 2011

(51) Int. Cl. G02B 7/192

(52) U.S. Cl. 359/853; 359/871

(57) ABSTRACT

A mirror module including one or more rib elements made of the same materials as a rear plate and/or front plate. The rib elements are placed between the rear glass plate and the front glass plate to afford rigidity to the mirror module. Since the rib elements are made of the same materials as the rear plate and/or front plate, the rib elements have the same or similar coefficients of thermal expansion as the rear plate or the front plate. Consequently, when the mirror module is subject to temperature fluctuation, the rib elements exert less stress on the glass plates compared to structure elements made of the materials different from the rear or front glass plate. The rib elements may also be integrated with the rear plate to simplify the process for manufacturing the mirror module.

### BACKGROUND OF THE INVENTION

1. Field of the Invention

The present invention relates to mirror modules used in heliostats with sufficient rigidity and strength to withstand various environmental elements.

2. Description of the Related Art

Power generation using solar energy has gained much attention as a source of renewable energy. A category of solar power generation system involves focusing solar energy to a central power tower using multitudes of heliostats dispersed in a field. The heliostats reflect and concentrate solar energy onto the central power tower. The central power tower leverages the concentrated light to generate power using either solar thermal energy (STE) or photovoltaics. A commercial power generation system may use hundreds or even thousands of heliostats.

Each heliostat has one or more mirrors for reflecting the solar energy to the central power tower. In order to increase the energy focused on the central power tower, some heliostat mirrors have concave reflective surfaces. Compared to flat surfaces, the concaved reflective surfaces allow light to be concentrated onto a smaller target area. Further, the heliostat mirrors are controlled by an actuation mechanism to track the trajectory of the sun, and hence, the heliostat mirrors focus the energy onto the central power tower at different times of the day.

The heliostats include mounts for securing heliostat mirrors. Without sufficient rigidity, a heliostat mirror will bend due to its weight when mounted, causing its reflective surface to deform. Moreover, the heliostat mirrors are deployed outdoors where the heliostat mirrors are exposed to various environmental elements such as wind, rain, dust and heat. If the heliostat mirrors do not possess sufficient strength and durability, the environmental elements may cause the heliostat mirrors to deform or crack over time. Such deformed or cracked heliostat mirrors cannot effectively focus the solar energy onto the central power tower, resulting in a lower overall efficiency of the solar power generation system. Eventually, such heliostat mirrors should be replaced or fixed, which adds cost associated with operating the solar power generation system. To reduce the cost, the frequency of replacements and the cost of each heliostat mirror should be minimized to the extent possible.

One of the environmental factors that significantly affect effective operational period of a heliostat mirror is the heat. In many instances, the solar power generation system operates in environment where temperature fluctuates significantly. With changes in the temperature, the heliostat mirror experiences expansion and contraction of its components. Different components in the heliostat mirror may have different coefficients of thermal expansion. As the heliostat mirrors are exposed to repeated temperature fluctuation, the components of heliostat mirrors experience repeated stress and strain. Such repeated stress and strain may eventually cause fatigue destruction of one or more components in the heliostat mirrors.

### SUMMARY OF THE INVENTION

Embodiments of the present invention relate to a mirror module for reflecting light. The mirror module includes a first plate, a second plate and a support structure between the first and second plates. The first plate has a reflective surface for reflecting light onto a target such as a central power tower. The second plate is separated from the first plate by the support structure. The support structure has the coefficient of thermal expansion that is identical or similar to the coefficient of thermal expansion of the first plate or the second plate.

In one embodiment, the support structure, the first plate and the second plate are made of glass.

### BRIEF DESCRIPTION OF THE DRAWINGS

The teachings of the embodiments of the present invention can be readily understood by considering the following detailed description in conjunction with the accompanying drawings.

Figure (FIG. 1 is a conceptual diagram illustrating a solar power generation system, according to one embodiment.

FIG. 2 is an exploded view of a mirror module according to one embodiment.

FIG. 3 is a cross sectional diagram illustrating a lateral rib element of a mirror module, according to one embodiment.

FIG. 4 is a perspective view diagram of a cross rib element of a mirror module, according to one embodiment.

FIG. 5 is a plan view of the cross rib element of FIG. 4, according to one embodiment.

FIG. 6 is a sectional view of the cross rib element of FIG. 4, according to one embodiment.

FIG. 7A is an exploded view of a mirror module having a molded rib element, according to one embodiment.

FIG. 7B is an exploded view of a mirror module having a molded rib element integrated with a glass plate, according to one embodiment.

FIG. 8A is an exploded view of a mirror module having hollow cylindrical rib elements, according to one embodiment.

FIG. 8B is an enlarged perspective view of the hollow cylindrical rib elements of FIG. 8A, according to one embodiment.

FIG. 9 is a plan view of the mirror module of FIG. 8A, according to one embodiment.

FIG. 10 is a sectional view of the mirror module of FIG. 9, according to one embodiment.

FIG. 11 is an enlarged sectional diagram illustrating mounting of a cylindrical rib element between a front glass plate and a rear glass plate, according to one embodiment.

FIG. 12 is a plan view of a mirror module using abutting cylindrical rib elements, according to one embodiment.

FIG. 13A is a diagram illustrating assembling of two notched rib elements, according to one embodiment.

FIG. 13B is a diagram illustrating assembling of two notchless rib elements, according to one embodiment.

FIGS. 14A through 14G are perspective diagrams of mirror modules using various rib elements in various arrangements, according to embodiments.

FIG. 15A is a sectional diagram of a mirror module using curved rib elements, according to one embodiment.

FIG. 15B is a sectional diagram of a mirror module using two curved rib elements, according to one embodiment.

### DETAILED DESCRIPTION OF EMBODIMENTS

The Figures (FIG.) and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention(s), examples of which are illustrated in the accompanying figures. It is noted that wherever practicable, similar or like reference numbers may be used in the figures and may indicate similar or like functionality. The figures depict embodiments of the present invention for purposes of illustration only.

Embodiments relate to a mirror module including one or more rib elements made of material having the same or similar coefficient of thermal expansion as a rear plate and/or front plate. The rib elements are placed between the rear plate and the front plate to afford rigidity and strength to the mirror module. When the mirror module is subject to temperature fluctuation, the rib elements exert less stress on the glass plates compared to structure elements made of materials having different coefficients of thermal expansion as the rear plate or the front plate. The rib elements may also be integrated with the rear plate to simplify the manufacturing process.

A front plate herein refers to a mirror with a reflective surface formed on a substrate. The reflective surface may be formed by applying a reflective coating (e.g., silver) to the substrate. The substrate may be glass or other transparent materials. The reflective surface is generally formed on an inner surface that is not exposed to the environment.

A rear plate herein refers to a substrate that is spaced away from the front plate. In one embodiment, the rear plate is a substrate made of materials such as glass. The rear plate need not be transparent. The rear plate may be integrated with rib elements.

A rib structure herein refers to a support structure placed between the front plate and the rear plate. The rib structure has the same or similar coefficient of thermal expansion as the front plate or the rear plate. In one embodiment, the rib structure is made of glass. The rib structure could consist of a single element or multiple elements.

### Overall Architecture of Solar Power Generation System

Figure (FIG. 1 is a conceptual diagram illustrating a solar power generation system 100, according to one embodiment. The solar power generating system 100 may include, among other components, a central power tower 120 and multiple heliostats 110A through 110C (hereinafter collectively referred to as “the heliostats 110”). Although only three heliostats 110 are illustrated in FIG. 1, there may be hundreds or even thousands of heliostats deployed in the solar power generation system 100.

The heliostats 110 reflect and focus solar energy onto the central power tower 120. For this purpose, each heliostat 110 includes a mirror 114A, 114B or 114C (hereinafter collectively referred to as the “mirrors 114” or “mirror modules 114”). The front surface of the mirrors 114 may be flat or concaved. The heliostats 110 also include mounts 118A through 118C onto which the mirrors 114 are mounted. The heliostats 110 may also include an actuating device (not shown) to move the mirrors 114 relative to the mounts 118A through 118C.

The central power tower 120 receives the solar energy from the heliostats 110 and generates electricity using a solar thermal system, photovoltaic solar cells or a combination thereof. The solar power system 100 may include a centralized or distributed control system (not shown) for adjusting the tilting and orientation of the mirrors 114 to increase the amount of solar energy sent to the central power tower 120.

Example Mirror Module with Long Lateral Rib Elements and Short Cross Rib Elements

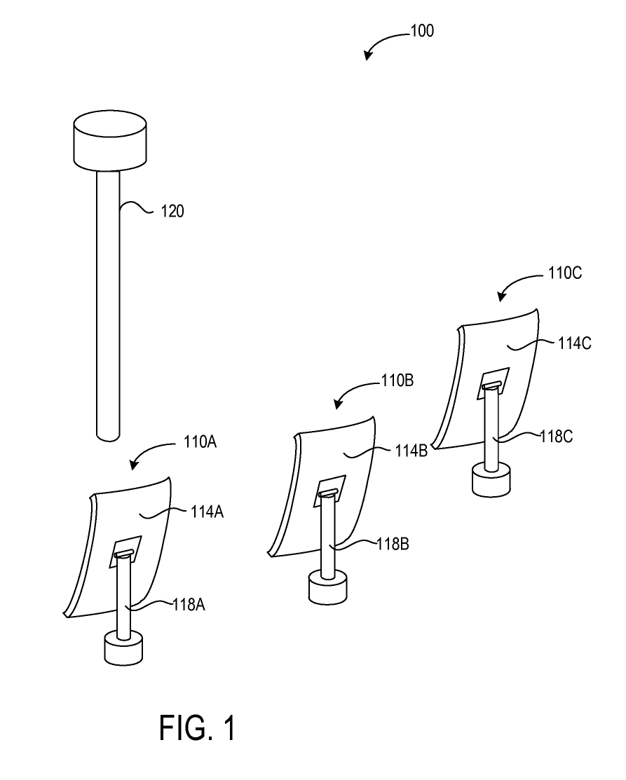

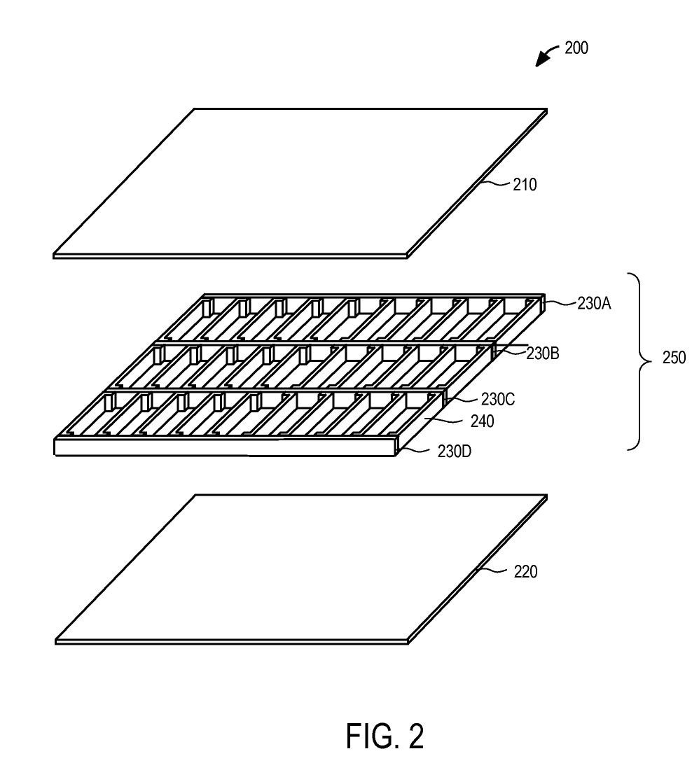

FIG. 2 is an exploded view of a mirror module 200 according to one embodiment. The mirror module 200 may include, among other components, a front plate 210, a rear plate 220, and a support structure 250. The front plate 210 includes a reflective surface for reflecting the light to the central power tower 120. In one embodiment, the reflective surface is formed on the rear surface of the front plate 210 facing the support structure 250. The rear plate 220 may include fixing structures (not shown) for securing to a mount and an actuation mechanism control. The fixing structures, for example, include brackets, holes for receiving screws, and frames. In one embodiment, the rear plate 220 may be fabricated to include such fixing structures. Alternatively, such fixing structures may be added to the rear plate 220 after the fabrication of the rear plate 220.

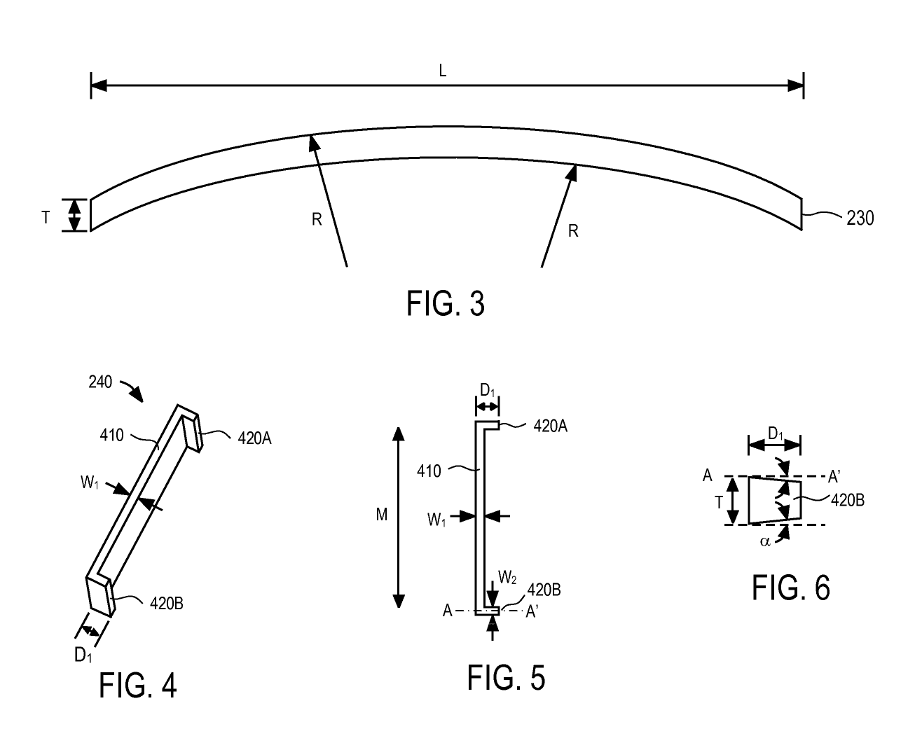

The support structure 250 provides strength and rigidity to the mirror module 200. The support structure 250 may include lateral rib elements 230A through 230D (hereinafter collectively referred to as “the lateral rib elements 230”) and cross rib elements 240. The lateral rib elements 230 extend laterally (horizontal direction in FIG. 2) across the mirror module 200, as described below in detail with reference to FIG. 3. The cross rib elements 240 extend in a direction perpendicular to the direction in which the lateral rib elements 230 extend. The configuration of cross rib elements is described below in detail with reference to FIGS. 4 through 6. The number of the cross rib elements 240 and the lateral rib elements 230 is merely illustrative; and more or less cross rib elements 240 and the lateral rib elements 230 may be used depending on the dimension of the mirror module 200.

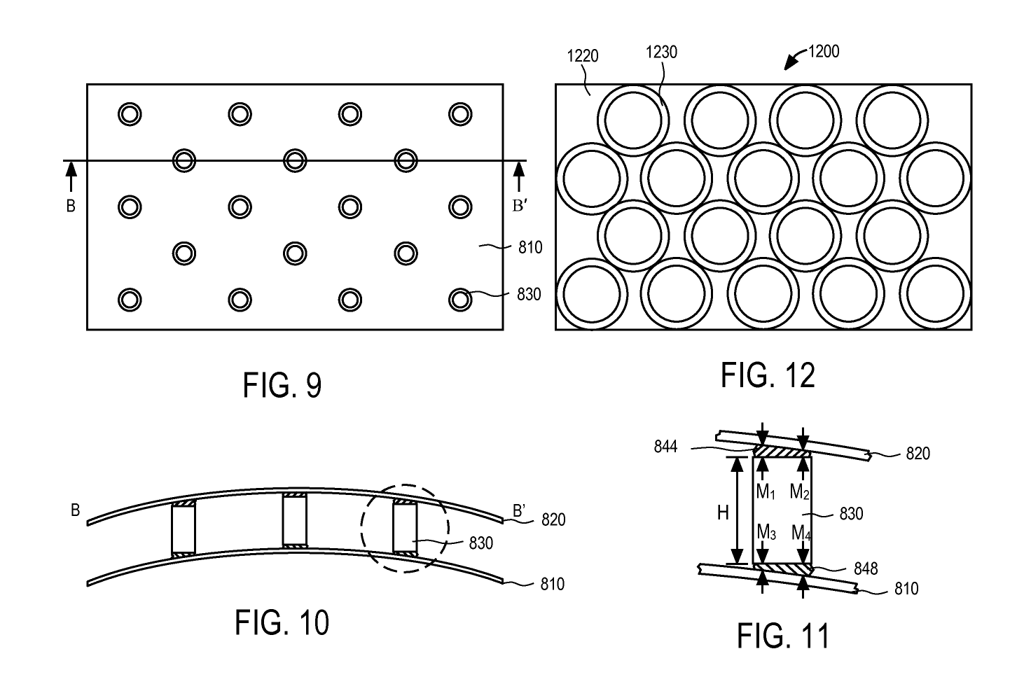

In one embodiment, the support structure 250 is made of material that has the same or similar coefficient of thermal expansion as the material of the front plate 210 and the rear plate 220. For example, the front plate 210, the rear plate 220 and the support structure 250 are all made of glass. Other materials such as plastic, metal, wood, cardboard, or ceramic materials also may be used if support structure is isolated or discontinuous as illustrated in FIG. 9. By using the same material in the front plate 210, the rear plate 220 and the support structure 250, elements in the mirror module 200 experience the same degree of thermal expansion or contraction with temperature fluctuation. Hence, the front plate 210 and the rear plate 220 experience less thermal stress and reduced distortion of the shape of the mirror module 200 due to temperature fluctuation compared to cases where the support structure 250 is made of other materials (e.g., metal or plastic).

The support structure 250 is secured between the front plate 210 and the rear plate 220 using, for example, adhesive (e.g., epoxy). When fabricating the mirror module 200, the front plate 210 or the rear plate 220 is placed on a contoured surface. Then, adhesive is applied and cured to secure the lateral rib elements 240 and the lateral rib elements 230 onto the front plate 210 or the rear plate 220. Then, adhesive are again applied and cured to secure the lateral rib elements 240 and the lateral rib elements 230 to the other plate. By assembling the plates 210, 220 and the support structure 250 on the contoured surface, a desired surface profile of the mirror module 200 may be obtained. The desired surface profile may be a concaved shape or a flat shape.

In one embodiment, the edges of the mirror module 200 are enclosed to prevent dirt or other pollutants from entering the interior of the mirror module 200. As illustrated in FIG. 2, two lateral rib elements 230A, 230D, along with the cross rib elements at the rightmost and leftmost edges enclose the edges of the mirror module 200. Alternatively, customized edge elements (not shown) may be used to seal the edges of the mirror module 200.

FIG. 3 is a cross sectional diagram illustrating a lateral rib element 230 in the mirror module 200, according to one embodiment. The lateral rib element 230 of FIG. 3 has a length L corresponding to the length of the front plate 210 and the rear plate 220, and has a height T defining the distance between the front plate 210 and the rear plate 220. Further, the lateral rib element 230 also has a radius of curvature R to shape the surface of the front plate 210 into a curved shape. In another embodiment, the lateral rib element 230 may have sectional profile of a parabolic shape instead of spherical shape (with curvature R as illustrated in FIG. 3). The parabolic shape is advantageous, among other reasons, because spherical aberration can be reduced compared to a spherical shape. In still another embodiment, the lateral rib element 230 may have a straight surface and instead vary the thickness of the adhesive between the front plate 210 and the lateral rib element 230 to shape the front surface of the front plate 210.

FIG. 4 is a perspective view of a cross rib element 240, according to one embodiment. The cross rib element 240 includes a body 410, and two legs 420A, 420B. The body 410 has a thickness of W₁, a length of M and a height of T (the same as the height of the lateral rib element 230). In one embodiment, W1 is 3 mm, M is 200 mm and T is 75 mm. The two legs 420A, 420B extend perpendicularly from the body 410 for a length D₁. The length D₁ of the body 410 is shorter than the length M of the body 410. In one embodiment, the length D₁ is 25 mm. The legs 420A, 420B provide more surface to allow more secure bonding between the cross rib element 240 and the lateral rib elements 230 by adhesive. That is, adhesive may be applied to the side surfaces of legs 420A, 420B and secured to the lateral rib elements 230. In another embodiment, the cross rib elements 240 may be constructed without the legs 420A, 420B.

FIG. 5 is a plan view of the cross rib element 240, according to one embodiment. The thickness W₁ of the body 410 is substantially the same as the thickness W₂ of the legs 420A, 420B.

FIG. 6 is a sectional view of the cross rib element 240 taken along line A-A′ of FIG. 5, according to one embodiment. The legs 420A, 420B may be tapered with an angle α so that the height of the legs 420A, 420B is taller at their base (connected to the body 410) and shorter at their ends. By tapering the height of the cross rib element 240, the legs 420A, 420B do not interfere with securing of the body 410 to the plates 210, 220 despite variances in the height of the legs 420A, 420B caused by fabrication processes. In one embodiment, the tapering angle α is about 10 degrees

Example Mirror Module with Molded Rib Elements

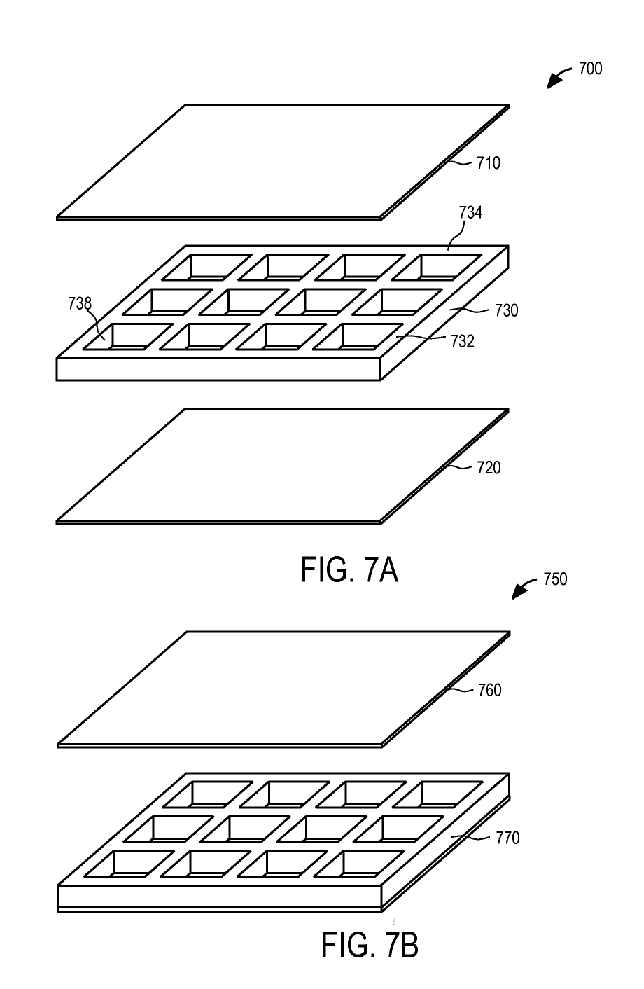

FIG. 7A is an exploded view of a mirror module 700 having a molded rib element 730, according to one embodiment. The molded rib element 730 is secured between a front plate 710 and a rear plate 720 to afford rigidity and strength to the mirror module 700. By using a single molded rib element 730 instead of multiple rib elements, the assembly process of the mirror module 700 may be simplified. Further, the single molded rib element 730 tends to be more rigid and robust compared to the support structure 250 of FIG. 2 since there are fewer adhesive joints that may fail.

The rib element 730 is made of the same material as the front and rear plates 710, 720 to prevent or reduce stress in the mirror module 700 caused by difference in coefficients of thermal expansion. In one embodiment, the rib element 730 is fabricated using the process of compression molding.

The molded rib element 730 includes laterally extending rib portions 734 and cross rib portions 732 extending in cross directions. Cavities 738 are formed on the molded rib element 730 to reduce the weight and the material used. Instead of using square shaped cavities, various other shapes of cavities (e.g., honeycomb shape) may be formed on the molded rib elements.

FIG. 7B is an exploded view of a mirror module 750 having a molded rib element 770 integrated with a rear plate, according to one embodiment. Instead of fabricating the rib element and the rear plate separately, the molded rib element 770 is fabricated with a rear plate using, for example, compression molding process. By integrating the molded rib element 770 with the rear plate 774, the manufacturing process of the mirror module 750 is further simplified. Further, the mirror module 750 can be made more rigid and robust compared to the mirror module 700 of FIG. 7A since there are fewer adhesive joints. The mirror module 750 can be fabricated by securing the molded rib element 770 to a front plate 760 using, for example, adhesive. Further, molded rib element 770 is made of the same material (e.g., glass) as the front plate 760 to reduce or remove thermal stress caused by difference in the coefficients of thermal expansion.

Example Mirror Module with Hollow Sectioned Rib Elements

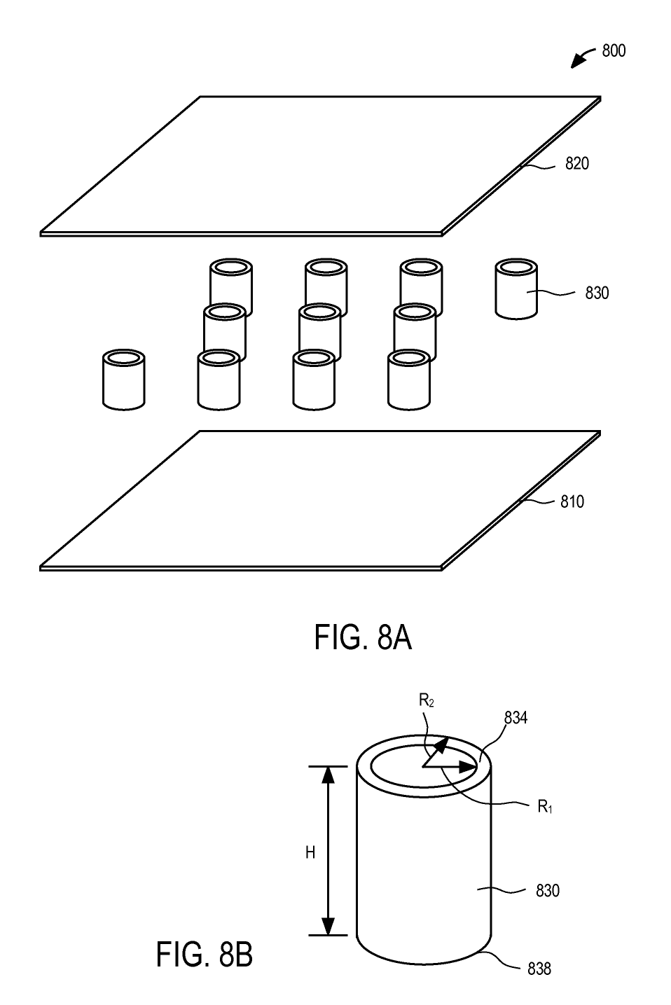

One or more ribs with hollow structural sections (HSS) may be used as rib elements between the plates of a mirror module. FIG. 8A is an exploded view of a mirror module 800 having hollow cylindrical rib elements 830, according to one embodiment. The mirror module 800 has a front plate 810, a rear plate 820 and the cylindrical rib elements 830 placed between the front plate 810 and a rear plate 820. The cylindrical rib elements 830 reduce the amount of materials used for the support structure while providing sufficient rigidity and strength to the mirror module 800. Further, materials having different coefficients of thermal expansion compared to the front plate 810 and the rear plate 820 may be used without causing significant stress or strain in the mirror module or distortion of the mirror module due to temperature fluctuation since the supports are intermittent.

FIG. 8B is an enlarged perspective view of the cylindrical rib element 830, according to one embodiment. The cylindrical rib 830 has an inner surface having a radius of R₁, an outer surface having a radius of R₂ and a height of H. In one embodiment, R₁ is around 25 mm, R₂ is around 28 mm, and H is around 75 mm. In one embodiment, the cylindrical rib element 830 is made of the same material (e.g., glass) as the front plate 810 and the rear plate 820. In one embodiment, the upper and lower surfaces 834, 838 of the cylindrical rib 830 are flat. The cylindrical rib element 830 is made of the same material (e.g., glass) as the front plate 810 and the rear plate 820, or may be made of an alternate material where cylindrical rib elements are used in a discontinuous manner in the mirror module.

FIG. 9 is a plan view of the mirror module 800 of FIG. 8A, according to one embodiment. As illustrated in FIG. 9, the cylindrical ribs 830 are placed in a staggered manner. Instead of placing the cylindrical ribs 830 in a staggered manner (as illustrated in FIG. 9), the cylindrical ribs may also be arranged along the same columns and rows. Various other patterns of deployment of cylindrical ribs such as spiral pattern and random pattern may also be used.

In one embodiment, more cylindrical ribs 830 can be placed around the area where the fixing structures for mounting the mirror module 800 is located. The areas of the mirror module 800 around the fixing structures tend to receive more force compared to other parts of the mirror module 800. Hence, by allocating more cylindrical ribs 830 in the vicinity of the fixing structure, the mirror module 800 can be made more rigid and robust with fewer cylindrical ribs 830.

FIG. 10 is a sectional view of the mirror module 800 taken along line B-B′ in FIG. 9, according to one embodiment. The cylindrical ribs 830 are placed upright between the front plate 810 and the rear plate 820.

FIG. 11 is an enlarged sectional diagram illustrating the cylindrical rib element 830 between a front glass plate 810 and a rear glass plate 820, according to one embodiment. The cylindrical rib elements 830 may have flat upper and lower surfaces. For such cylindrical rib elements, the thickness of the adhesive is varied to shape the surface of the front plate 810 into a concaved shape. For example, the thickness M₃ of the adhesive at the bottom left portion of the cylindrical rib 830 is thinner than the thickness M₄ of the adhesive at the bottom right portion. To shape the rear plate 820 in a similar shape, the thickness M₁ of the adhesive at the upper left portion of the cylindrical rib 830 is thicker than the thickness M₂ of the adhesive at the upper right portion. In one embodiment, the cylindrical rib 830 is oriented perpendicular to the surface of the front plate 830 or the rear plate 820 to reduce variation in adhesive thickness.

A fabrication method described above with reference to FIG. 2 may be used to fabricate the mirror module 800. That is, the front plate 810 may be placed on a contoured surface. Then the adhesive is applied between the cylindrical rib elements 830 and the front plate 810 to secure the cylindrical rib elements 830 to the front plate 810. Then, the adhesive is applied between the upper surfaces of the cylindrical rib elements 830 and the rear plate 820 to secure the rear plate 820 to the cylindrical rib elements 830. The assembled mirror module 800 may be placed on the contoured surface for duration sufficient to cure the adhesive.

FIG. 12 is a plan view of a mirror module 1200 using abutting cylindrical rib elements 1230 on a rear plate 1220, according to one embodiment. The embodiment of FIG. 12 is similar to the embodiment of FIGS. 8A through 10 except that the cylindrical rib elements 1230 are larger than the cylindrical rib elements 830 or are placed closer together so that the cylindrical rib elements 830 abut each other. Due to the increased size or reduced spacing, the cylindrical rib elements 830 abut each other. By abutting the cylindrical rib elements 830, the mirror module may be more resistive against shear loading.

Although only cylindrical ribs were described above with reference to FIGS. 8A through 12, rib elements having different HSS profile may also be used. For example, hollow rib elements having a rectangular or elliptic HSS profile may be used instead of a cylindrical profile.

### Example Arrangements of Rib Elements

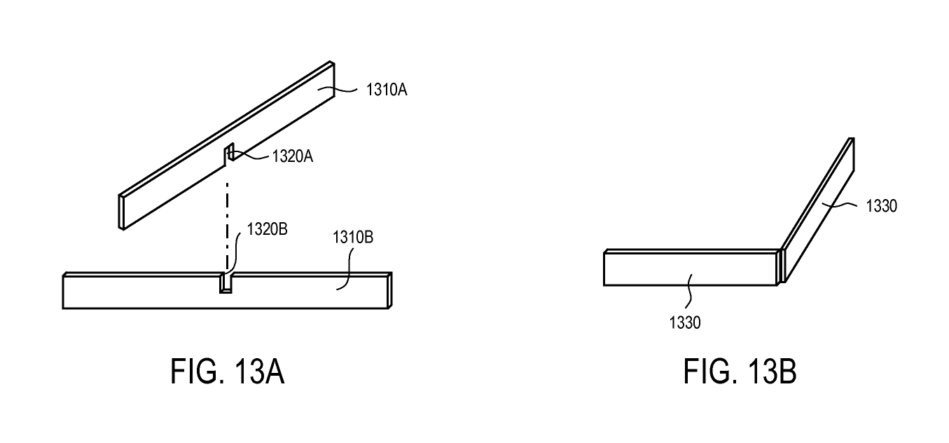

FIG. 13A is a diagram illustrating assembling of two notched rib elements 1310A, 1310B, according to one embodiment. Each of the notched rib elements 1310A, 1310B has a notch 1320A, 1320B formed on its body to allow secure fitting with another rib element. By assembling the rib elements 1310A, 1310B through the notches, the rib elements 1310A can cross each other without having to segment the rib elements 1310A, 1310B into multiple segments. In this way, the use of smaller rib elements can be obviated, thereby reducing the part count in the mirror module. These notched rib elements may be secured to the front and rear plates at various locations to provide rigidity and strength to a mirror module.

In one embodiment, the upper and lower surfaces of the notched rib elements are applied with adhesive for securing to the front and rear plates. The notched rib elements 1310A, 1310B may be made of material the same as the front and rear plates.

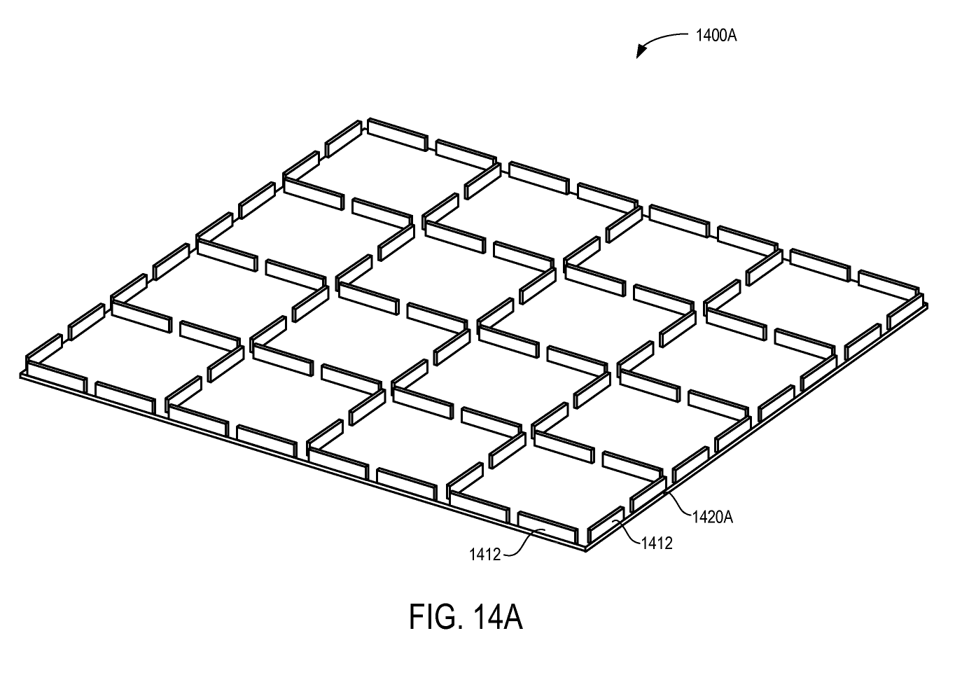

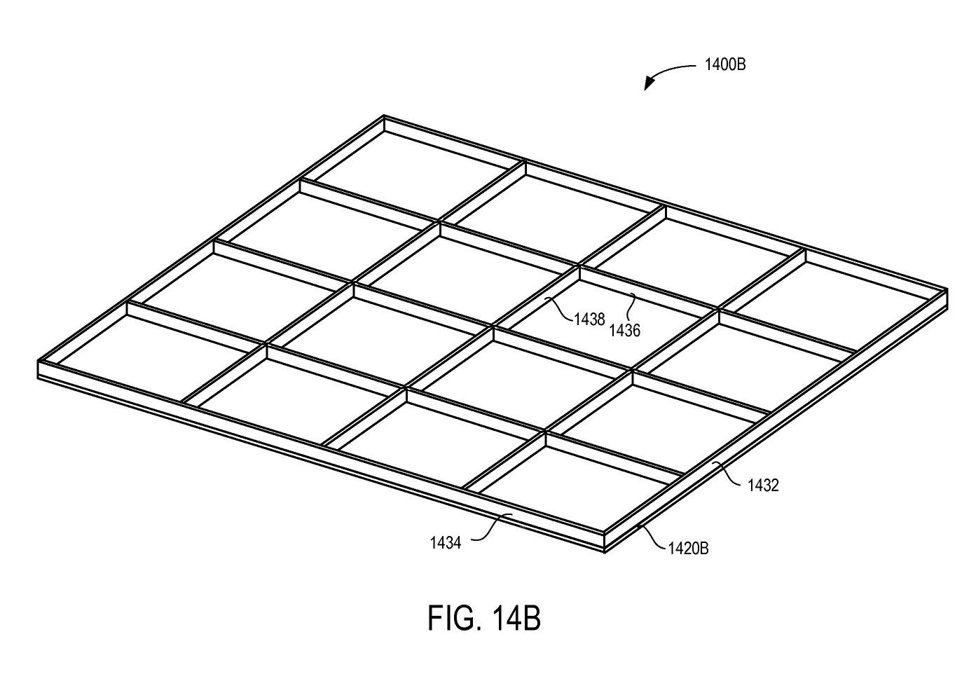

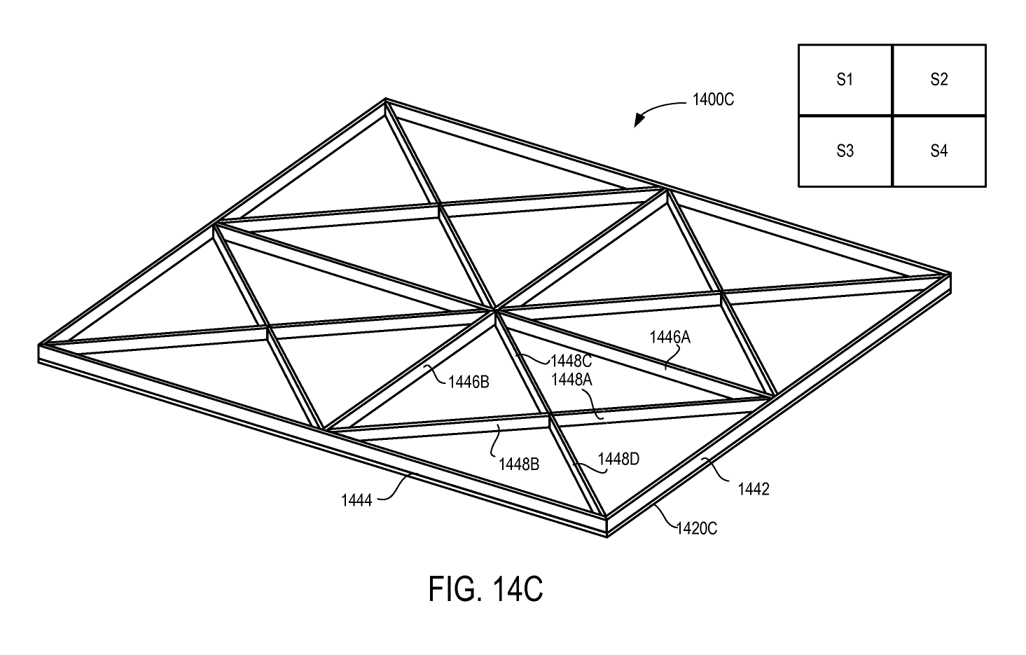

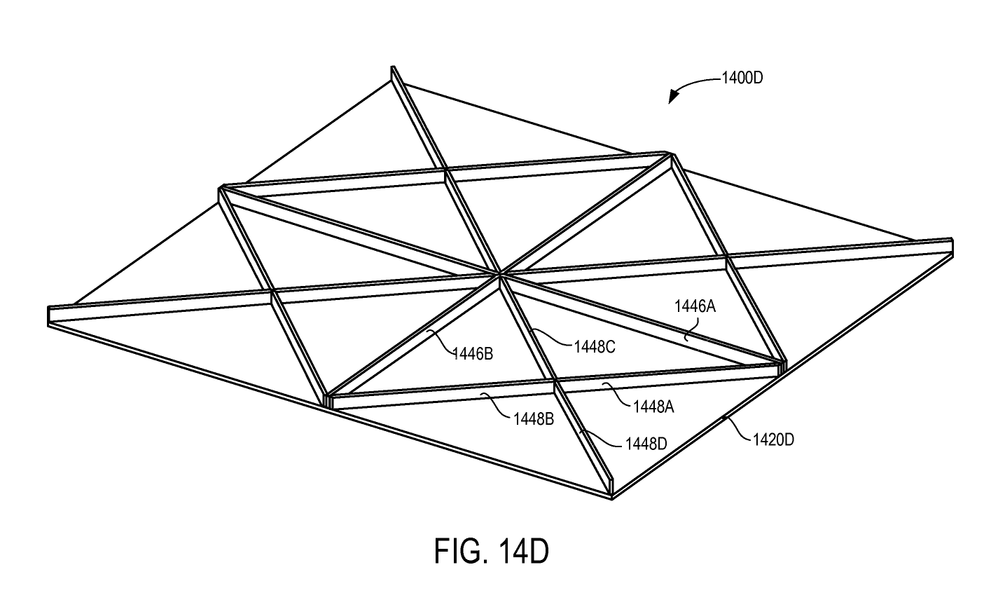

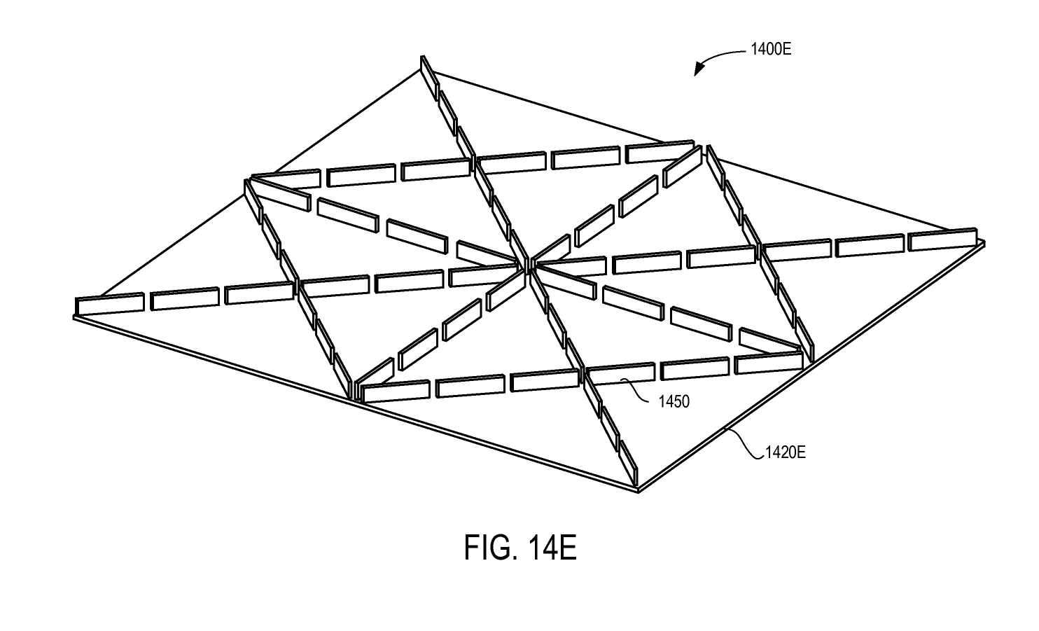

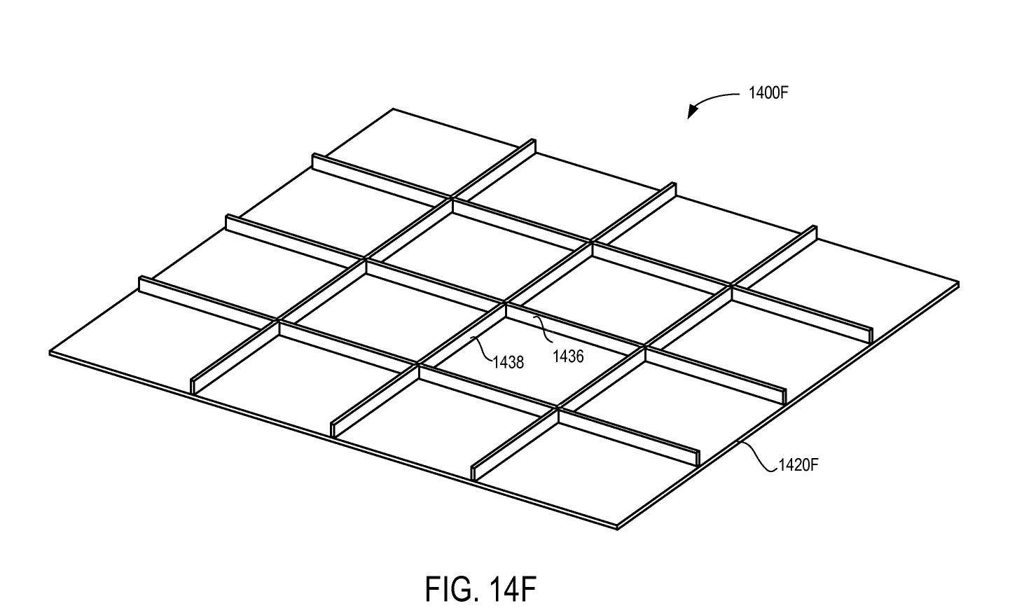

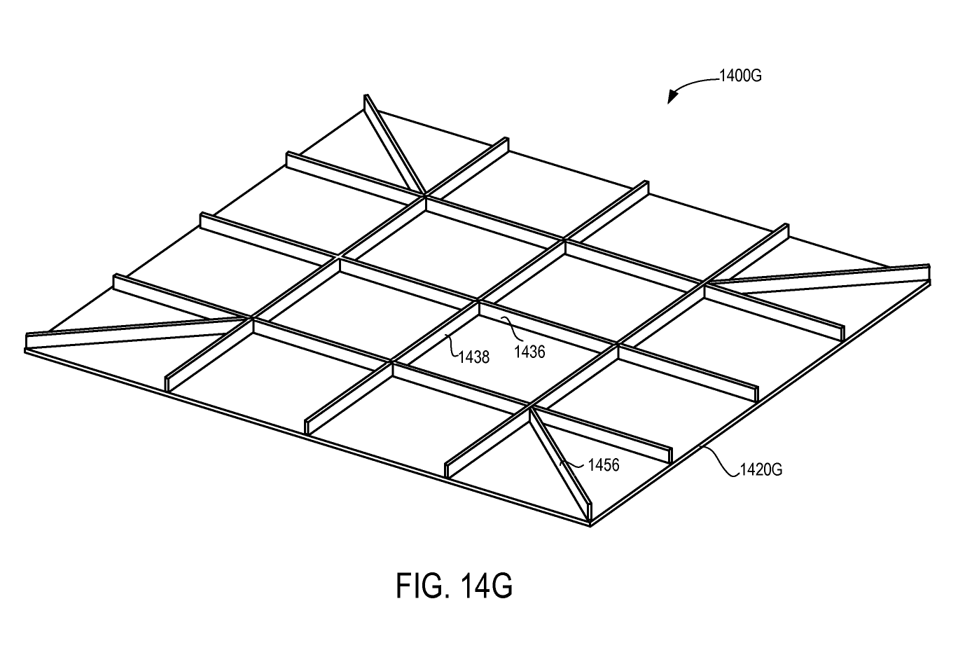

FIG. 13B is a diagram illustrating assembling of two notchless rib elements 1330, according to one embodiment. A single type of notchless rib elements may be used in a single mirror module. Alternatively, multiple types of notchless rib elements with different configurations may be used in a single mirror module. The upper and lower surfaces of the notchless rib elements 1330 are placed in various locations of a mirror module to provide strength and rigidity to the mirror module, as described below in detail with reference to FIG. 14A through 14G. The notchless rib elements 1330 may be made of materials same as the front and rear plates.

FIGS. 14A through 14G are perspective diagrams of mirror modules using various notchless rib elements placed in various arrangements, according to embodiments. FIG. 14A illustrates a rib structure 1400A on a front plate 1420A. The rib structure 1400A uses single rectangular shaped notchless rib elements 1412 with a predetermined thickness. Multiple notchless rib elements 1412 are arranged in rows and columns, and secured to a front plate 1420A and a rear plate (not shown) to form a mirror module. The configuration of the mirror module can be modified by increasing or decreasing the number of notchless rib elements 1412 in a row or column. Moreover, the notchless rib element 1412 is short compared to, for example, the lateral rib elements 230 of FIG. 2. Hence, the notchless rib elements 1412 allow greater mirror curvature without exceeding a reasonable variation in the thickness of the adhesive layer.

FIG. 14B illustrates another rib structure 1400B for a mirror module, according to one embodiment. The mirror module may have a rectangular shape, in which case the rib structure 1400B uses four different types of rib elements mounted on a front plate 1420B: a long cross rib element 1432, a long lateral rib element 1434, a short lateral rib element 1436 and a short cross rib element 1438. The interior of the rib structure 1400 includes rows and columns of short lateral rib elements 1436 and short cross rib elements 1438. The four edges of the rib structure 1400B are covered by the long cross rib elements 1432 and the long lateral rib elements 1434. Alternatively, the mirror module may have a square shape, in which case the rib structure 1400B uses two types of rib elements: a long cross rib element 1432 (having the same configuration as the long lateral rib element 1434) and a short lateral rib element 1436 (having the same configuration as the short lateral rib element 1438).

FIG. 14C illustrates another rib structure 1400C for a mirror module, according to one embodiment. The rib structure 1400C can be divided into four segments S1 through S4. The rib structure 1400C is mounted on a front plate 1420C. A horizontal rib element 1446A and a vertical rib element 1446B separates one segment from other segments. Taking the example of segment S4, the segment is separated from segment S2 by the horizontal rib element 1446A and is separated from the segment S3 by the vertical rib element 1446B. The four edges of the rib structure 1400C are placed with two long lateral rib elements 1444 and two long cross rib elements 1442. In each segment, four diagonal rib elements 1448A through 1448D are placed in diagonal directions. The four corners of a mirror module may often experience distortion or crack. In the rib structure 1400C, each of the four corners is supported by a diagonal rib element 1448D, and thereby advantageous reduces distortion or crack at the four corners of the mirror module.

FIG. 14D illustrates a rib structure 1400D that is essentially the same as the rib structure 1400C of FIG. 14C except that is the rib structure 1400D lacks the long lateral rib elements 1444 and the long cross rib elements 1442. The rib structure 1400D is placed on a front plate 1400D.

FIG. 14E illustrates a rib structure 1400E that is similar to the rib structure of FIG. 14D. In the rib structure 1400E, multiple short rib elements 1450 replaces horizontal rib elements 1446A, vertical rib elements 1446B and diagonal rib elements 1448A through 1448D. The multiple short rib elements are placed on a front plate 1420E.

FIG. 14F illustrates a rib structure 1400F that is similar to the rib structure 1400B of FIG. 14B. The rib structure 1400F lacks the long cross rib elements 1432 and the long lateral rib elements 1434 placed on four corners of a front plate 1420F.

FIG. 14G illustrates a rib structure 1400G that is similar to the rib structure 1400F of FIG. 14F except that the rib structure 1400G includes four diagonal rib elements 1456 extending to the four corners of a front plate 1420G.

In embodiments described above, one or more rib elements may have upper or lower surfaces that are flat. Despite the flat upper or lower surfaces, a concaved surface of the front plate 1420B can be obtained by varying the thickness of adhesive between the plates and the rib elements, as described above in detail with reference to FIG. 10.

The rib structures 1400A through 1400G are merely illustrative. Various other rib structures and other configurations of rib elements may be used. For example, notched ribs may replace the notchless rib elements partially or entirely.

Mirror Module with Curved Rib Elements

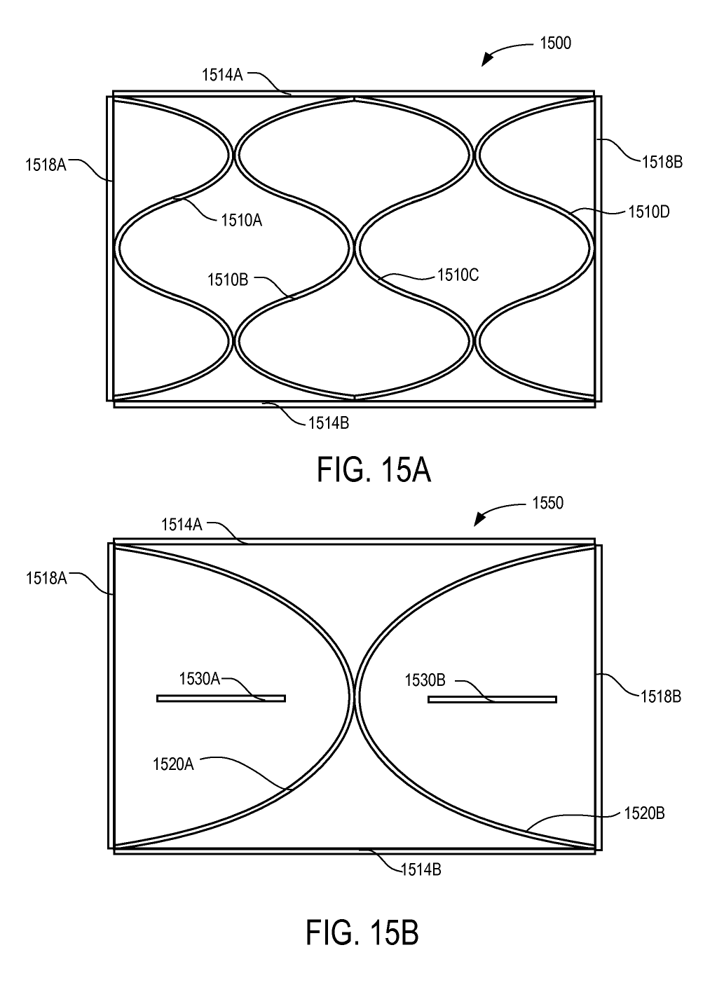

FIG. 15A is a sectional diagram of a mirror module 1500 using corrugated rib elements 1510A through 1510D, according to one embodiment. The ends of the corrugated rib elements 1510A and 1510D extend from one corner of the mirror module 1500 to another corner of the mirror module 1500. Further, the four edges of the mirror module 1500 may be shielded by straight ribs 1514A, 1514B, 1518A and 1518B. The corrugated rib elements 1510A through 1510 may have sectional profiles that are curved to shape the mirror module 1500 to have a curved cross section (e.g., shape the mirror module 1500 into a spherical shape or a parabolic shape).

The use of corrugated rib elements 1510A through 1510D advantageously allows use of fewer rib elements in the mirror module 1500. The corrugated rib elements 1510A through 1510D as well as the straight ribs 1514A, 1514B, 1518A and 1518B may be made of the same material as the front plate and the rear plate of the mirror module 1500 to reduce thermal stress caused by difference in the coefficients of thermal expansion in the rib structure and the plates.

FIG. 15B is a sectional diagram of a mirror module 1550 using two curved rib elements 1520A and 1520B, according to one embodiment. In addition to the curved rib elements 1520A and 1520B, straight ribs 1530A and 1530B may also be added to provide support. The four edges of the mirror module 1550 are shielded by straight ribs 1514A, 1514B, 1518A and 1518B. The curved rib elements 1520A and 1520B may be made of the same material as the front plate and the rear plate of the mirror module 1550.

The rib elements described above with reference to various embodiment may be fabricated using methods including, but not limited to, abrasive jet (i.e., water jet cutting), scribe and break method, laser scribe, compression molding, blow molding and underwater cutting.

Although support structures are described above primarily with respect to mirror modules used in heliostats, the same support structure may also be used in mirrors for other purposes such as decorative wall mirrors, mirrors in solar trough systems, and solar dish reflectors. The support structure may also be used in other structures such as photovoltaic panel.

Upon reading this disclosure, those of ordinary skill in the art will appreciate still additional alternative structural and functional designs through the disclosed principles of the present invention. Thus, while particular embodiments and applications of the present invention have been illustrated and described, it is to be understood that the invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as defined in the appended claims.

What is claimed is:

1. A mirror module, comprising:
a first plate having a reflective surface for reflecting light onto a target;
a second plate separated from the first plate; and
a support structure secured between an inner surface of the first plate and an inner surface of the second plate, the support structure having a coefficient of thermal expansion identical to a coefficient of thermal expansion of the first plate or the second plate.

2. The mirror module of claim 1, wherein the first plate, the second plate and the support structure are made of glass.

3. The mirror module of claim 2, wherein the support structure comprises a plurality of extending rib elements.

4. The mirror module of claim 3, wherein the plurality of ribs comprises:
a plurality of lateral rib elements, each lateral rib element extending from one edge of the first plate to an opposite edge of the first plate; and
a plurality of cross rib elements extending between two of the plurality of lateral rib elements.

5. The mirror module of claim 4, wherein each of the lateral rib elements has a top surface and a bottom surface contoured to have a curved shape.

6. The mirror module of claim 4, wherein each of the cross rib elements comprises:
a body extending between two lateral rib elements; and
two legs extending perpendicularly from ends of the body to abut the lateral rib elements, each leg having a length shorter than the body and tapered to have a height decreasing in a direction away from the body.

7. The mirror module of claim 1, wherein the support structure and the second plate are fabricated into a single integrated piece.

8. The mirror module of claim 1, further comprising a first layer of adhesive between the support structure and the first plate, and a second layer of adhesive between the support structure and the second plate.

9. The mirror module of claim 8, wherein a thickness of the first layer of adhesive is configured to form a surface of the front plate having a concaved profile.

10. The mirror module of claim 1, wherein the support structure comprise a plurality of ribs with hollow structural section (HSS).

11. The mirror module of claim 10, wherein at least one rib is a hollow cylinder.

12. The mirror module of claim 1, wherein the support structure comprises a plurality of notched ribs connected to each other at locations where notches are formed.

13. The mirror module of claim 1, wherein the support structure comprises a plurality of sets of ribs, each set of ribs extending from one edge of the first plate to another edge of the first plate.

14. The mirror module of claim 1, wherein the support structure comprises a plurality of sets of rib elements, each rib element having a same configuration.

15. The mirror module of claim 14, wherein the rib elements of the support structure have a same configuration.

16. The mirror module of claim 1, wherein the support structure comprises rib elements extending to corners of the first plate.

17. The mirror module of claim 1, wherein the support structure comprises corrugated rib elements extending from one edge of the first plat to another edge of the first plate.

18. The mirror module of claim 1, wherein the support structure comprises rib elements surrounding edges the mirror module.

19. A heliostat comprising:
a mirror module, comprising:
a first plate having a reflective surface for reflecting light onto a target,
a second plate separated from the first plate, and
a support structure secured between an inner surface of the first plate and an inner surface of the second plate, the support structure having a coefficient of thermal expansion identical to a coefficient of thermal expansion of the first plate or the second plate; and
a fixing structure configured to secure the mirror module to a mount.

20. A solar power generation system comprising:
a plurality of heliostats, each heliostat comprising:
a first plate having a reflective surface for reflecting light onto a power tower,
a second plate separated from the first plate, and
a support structure secured between an inner surface of the first plate and an inner surface of the second plate, the support structure having a coefficient of thermal expansion identical to a coefficient of thermal expansion of the first plate or the second plate; and
the power tower configured to generate electricity based on solar energy reflected by the plurality of heliostats.
